(19) United States
(12) Patent Application Publication
(10) Pub. No.: US 2017/0054128 A1
(43) Pub. Date: Feb. 23, 2017

(54) Battery Cell with Temperature Sensor

(71) Applicant: Ford Global Technologies, LLC, Dearborn, MI (US)

(72) Inventors: Brian Joseph ROBERT, St. Clair Shores, MI (US); Mohan KARULKAR, Dearborn, MI (US)

(21) Appl. No.: 14/831,333

(22) Filed: Aug. 20, 2015

(51) Int. Cl. H01M 2/30; H01M 10/04; H01M 10/42

(52) U.S. Cl. CPC H01M 2/30; H01M 10/4257; H01M 10/4207; H01M 10/0481; H01M 2200/10; H01M 2220/20

(57) ABSTRACT

A traction battery includes a plurality of cells arranged in an array and each having a pouch with an outer surface. The traction battery also includes a circuit board having terminal receptacles. A thermal couple is disposed on the outer surface of one of the cells, and includes first and second legs each formed of a metal film. Each of the legs has a terminal extending away from the pouch and inserted into one of the terminal receptacles.

### TECHNICAL FIELD

The present disclosure relates to traction battery assemblies for hybrid and fully electric vehicles, and specifically to battery assemblies having cells with a thermocouple disposed on an outer surface of the cell.

### BACKGROUND

The need to reduce fuel consumption and emissions in automobiles and other vehicles is well known. Vehicles are being developed that reduce reliance or completely eliminate reliance on internal-combustion engines. Electrified vehicles are one type of vehicle currently being developed for this purpose.

Electrified vehicles contain a traction battery assembly to act as an energy source for the vehicle. The traction battery may include components and systems to assist in managing vehicle performance and operations. The traction battery may also include high-voltage components, and may include an air or liquid thermal management system to control the temperature of the battery.

### SUMMARY

According to one embodiment, a traction battery includes a plurality of cells arranged in an array and each having a pouch with an outer surface. The traction battery also includes a circuit board having terminal receptacles. A thermal couple is disposed on the outer surface of one of the cells, and includes first and second legs each formed of a metal film. Each of the legs has a terminal extending away from the pouch and inserted into one of the terminal receptacles.

According to another embodiment, a traction battery includes a cell array with at least one cell having a pouch defining a tab extending therefrom. A thermal couple is disposed on the pouch, and includes first and second legs formed of a metal film. A terminal portion of the first leg is disposed on the tab.

According to yet another embodiment, a method of applying a thermal couple to a cell having a pouch, the method includes applying a first ink, having a first metal powder, to an outer surface of the pouch. The method also includes applying a second ink, having a second metal powder, to the outer surface such that the first and second inks connect at a junction. The first and second metal powders are dissimilar metals configured to produce a thermoelectric (or Seebeck) effect.

### BRIEF DESCRIPTION OF THE DRAWINGS

FIG. 1 is a schematic diagram of an example hybrid vehicle.

FIG. 2 is a perspective view of a battery cell including a thermocouple.

FIG. 3 is a magnified front view illustrating a terminal side of a battery cell according to one embodiment.

FIG. 4 is a magnified front view illustrating a terminal side of a battery cell according to another embodiment.

FIG. 5 is a perspective view of a battery cell including a multiple thermocouples.

FIG. 6 is an exploded view of a traction-battery assembly.

FIG. 7 is a schematic illustration showing a control board and a battery cell.

FIG. 8 is a schematic perspective view of a receiving board and a battery cell.

FIG. 9 is a flowchart describing a method for applying a thermal couple to a battery cell.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the present invention. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

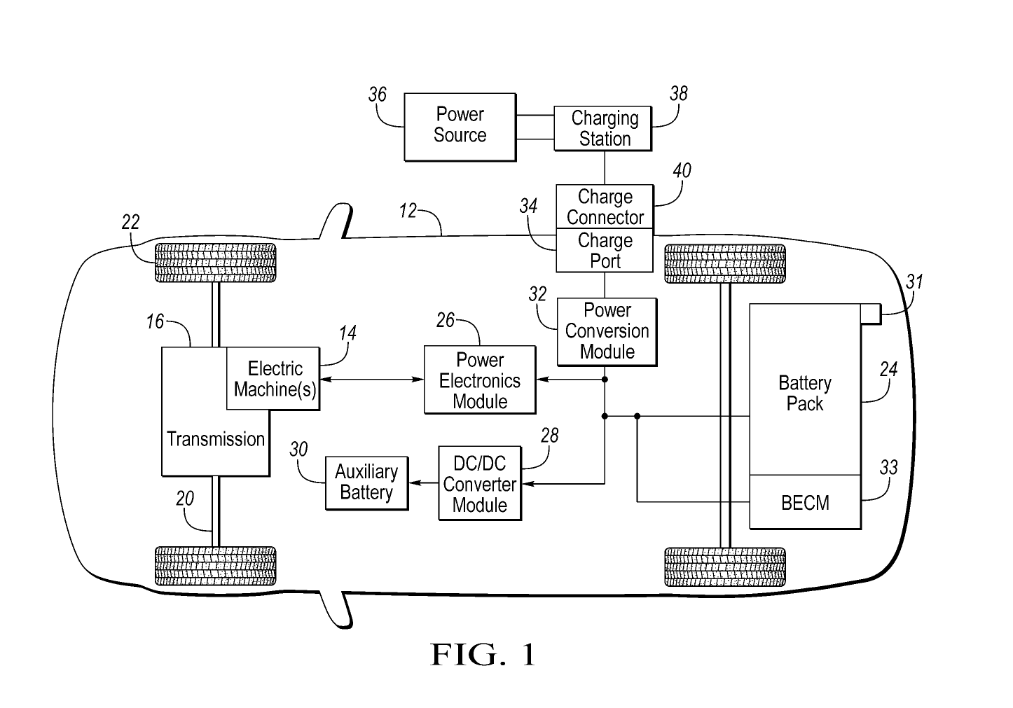

FIG. 1 depicts a schematic of a typical battery-electric vehicle (BEV). Certain embodiments, however, may also be implemented within the context of plug-in hybrid-electric vehicles. The vehicle 12 includes one or more electric machines 14 mechanically connected to a transmission 16. The electric machines 14 may be capable of operating as a motor or a generator. If the vehicle is a hybrid-electric vehicle, the transmission 16 is mechanically connected to an engine. The transmission 16 is mechanically connected to the wheels 22 via a drive shaft 20. The electric machines 14 can provide propulsion and deceleration capability. The electric machines 14 also act as generators and can provide fuel economy benefits by recovering energy through regenerative braking.

A fraction battery or battery pack 24 stores energy that can be used by the electric machines 14. The fraction battery 24 typically provides a high voltage direct current (DC) output from one or more battery cell arrays, sometimes referred to as battery cell stacks, within the traction battery 24. The battery cell arrays may include one or more battery cells.

The battery cells (such as a prismatic, pouch, cylindrical, or any other type of cell), convert stored chemical energy to electrical energy. The cells may include a housing, a positive electrode (cathode) and a negative electrode (anode). An electrolyte may allow ions to move between the anode and cathode during discharge, and then return during recharge. Terminals may allow current to flow out of the cell for use by the vehicle.

Different battery pack configurations are available to address individual vehicle variables including packaging constraints and power requirements. The battery cells may be thermally regulated with a thermal management system. Examples of thermal management systems include air cooling systems, liquid cooling systems, and a combination of air and liquid systems.

The traction battery 24 may be electrically connected to one or more power electronics modules 26 through one or more contactors (not shown). The one or more contactors isolate the traction battery 24 from other components when opened, and connect the traction battery 24 to other components when closed. The power electronics module 26 may be electrically connected to the electric machines 14 and may provide the ability to bi-directionally transfer electrical energy between the traction battery 24 and the electric machines 14. For example, a typical traction battery 24 may provide a DC voltage while the electric machines 14 may require a three-phase alternating current (AC) voltage to function. The power electronics module 26 may convert the DC voltage to a three-phase AC voltage as required by the electric machines 14. In a regenerative mode, the power electronics module 26 may convert the three-phase AC voltage from the electric machines 14 acting as generators to the DC voltage required by the traction battery 24.

In addition to providing energy for propulsion, the traction battery 24 may provide energy for other vehicle electrical systems. A typical system includes a DC/DC converter module 28 that converts the high voltage DC output of the traction battery 24 to a low voltage DC supply that is compatible with other vehicle components. Other high-voltage loads, such as air conditioning compressors and electric heaters, may be connected directly to the high-voltage supply without the use of a DC/DC converter module 28. In a typical vehicle, the low-voltage systems may be electrically connected to the DC/DC converter or an auxiliary battery 30 (e.g., a 12 volt battery).

A battery energy control module (BECM) 33 may be in communication with the traction battery 24. The BECM 33 may act as a controller for the traction battery 24 and may also include an electronic monitoring system that manages temperature and charge state of each of the battery cells. The traction battery 24 may have a temperature sensor 31 such as a thermistor or other temperature gauge. The temperature sensor 31 may be in communication with the BECM 33 to provide temperature data regarding the traction battery 24.

The vehicle 12 may be recharged by an external power source 36. The external power source 36 may be the power grid or may be a local power source (e.g. solar power). The external power source 36 is electrically connected to a vehicle charging station 38. The charger 38 may provide circuitry and controls to regulate and manage the transfer of electrical energy between the power source 36 and the vehicle 12. The external power source 36 may provide DC or AC electric power to the charger 38. The charger 38 may have a connector 40 for plugging into a charge port 34 of the vehicle 12. The charge port 34 may be any type of port configured to receive power from the charger 38. The charge port 34 may be electrically connected to an on-board power conversion module 32. The power conversion module 32 may condition the power supplied from the charger 38 to provide the proper voltage and current levels to the fraction battery 24. The power conversion module 32 may interface with the charger 38 to coordinate the delivery of power to the vehicle 12. The connector 40 may have pins that mate with corresponding recesses of the charge port 34. In other embodiments, the charging station may be an induction charging station. Here, the vehicle may include a receiver that communicates with a transmitter of the charging station to wirelessly receive electric current.

The various components discussed may have one or more controllers to control and monitor the operation of the components. The controllers may communicate via a serial bus (e.g., Controller Area Network (CAN)) or via dedicated electrical conduits. The controller generally includes any number of microprocessors, ASICs, ICs, memory (e.g., FLASH, ROM, RAM, EPROM and/or EEPROM) and software code to co-act with one another to perform a series of operations. The controller also includes predetermined data, or “look up tables” that are based on calculations and test data, and are stored within the memory. The controller may communicate with other vehicle systems and controllers over one or more wired or wireless vehicle connections using common bus protocols (e.g., CAN and LIN). Used herein, a reference to “a controller” refers to one or more controllers.

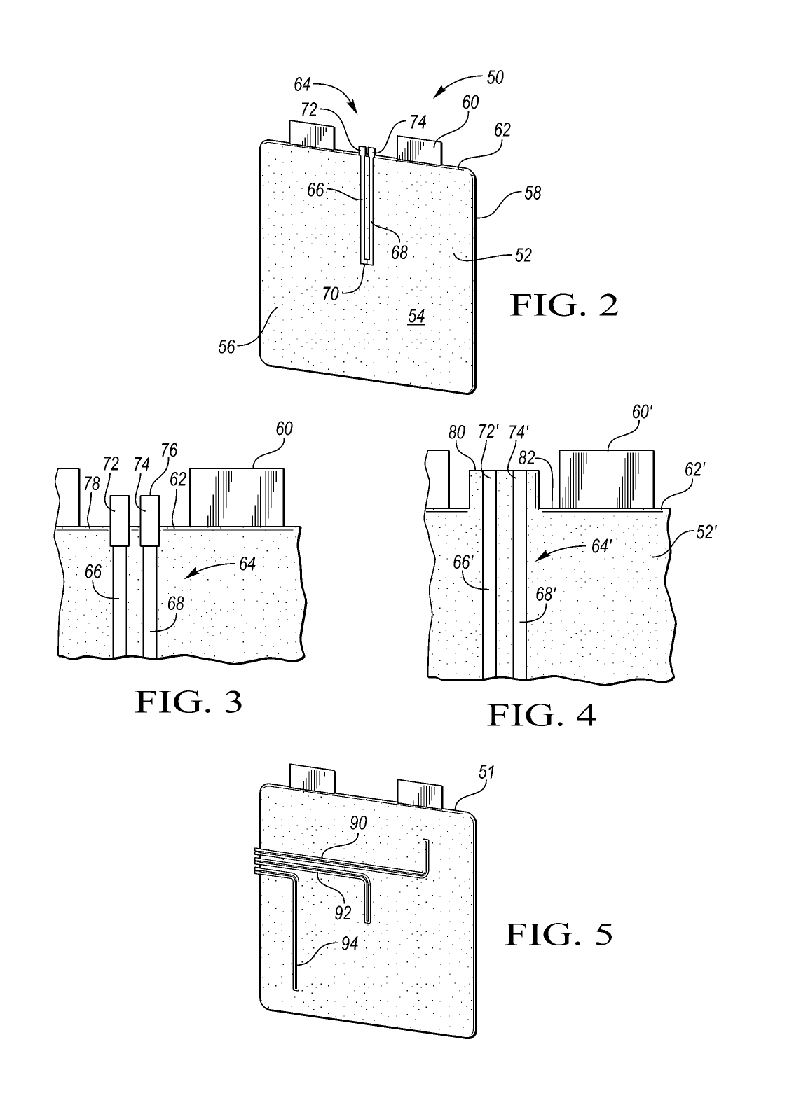

Referring to FIG. 2, the traction battery 24 includes a plurality of cells 50 arranged in one or more arrays. The cell 50 may be a pouch cell as illustrated, or may be another type of cell. The cell 50 includes a pouch 52 that houses the inner components of the cell. The pouch 52 has an outer surface or skin 54. The cell 50 may include a pair of major sides 56, and mirror sides 58 extending between the major sides. The terminals 60 of the cell extend from one or more of the mirror sides 58. The mirror side from which the terminals 60 extend is known as the terminal side 62 of the cell 50.

The cells 50 generate heat during charging and discharging of the battery 24. In order to properly control the battery 24, one or more vehicle controllers receive a signal indicating the temperature of the battery 24. Many prior art solutions determine an average temperature for the battery pack and use the average temperature as an input for the controller. These systems, at most, have a handful of sensors (typically thermistors) disposed in select areas. The problem with using an average battery temperature is that each of the cells may heat unequally and may have drastically different temperatures than other cells in the array. The various portions of individual cells 50 also heat unevenly. Typically, the cells 50 generate more heat towards the terminal side 62 than in other areas of the cell. To optimize battery operation and insure extended battery life, it is advantageous to have an accurate picture of the temperature the battery pack 24 and of each cell 50.

A thermocouple 64 may be used as a temperature sensor for the cells 50. In some embodiments, each cell within the array includes a thermocouple 64. In other embodiments, only some of the cells include a thermocouple 64. Thermocouples are inexpensive and have a small footprint compared to other temperature sensors currently being used. Because of this, a greater number of thermocouples may be included in the battery pack 24 as compared to other types of temperature sensors. The thermocouple 64 may be disposed on the outer skin 54 of one of the major sides 56. The thermocouple 64 includes a first leg 66 and a second leg 68 that are connected at a junction 70. The legs are also known as traces. The first and second legs are formed of dissimilar metals suitable to produce a thermoelectric effect (also known as the Seebeck effect). Suitable metal pairs include nickel-copper, chromel-constantan, chromel-alumel, iron-constantan, platinum-rhodium, copper-constantan and many others. The thermocouple 64 also includes a first terminal 72 connected to the first leg 66 and a second terminal 74 connected to the second leg 68. The first and second terminals 72, 74 are electrically connected to the controller either directly or indirectly.

The legs of the thermocouple 64 may be metal strips or wires, or may be a metallic film formed of dried ink or paint. The metallic film is electrically conductive and flexible. In one embodiment, each of the legs is formed of a metallic film that is painted, printed, or drawn onto the outer skin 54 of the pouch 52. The metallic ink or paint may be applied onto the pouch 52 via inkjet printing, screen printing, or applied by hand using a pen or paintbrush. The pouch 52 is a flexible, non-metallic, and non-conductive material such as aluminum-polymer laminate. The film must also be flexible and capable of binding to the outer skin of the pouch 52. A film thermocouple is extremely thin (orders of magnitude thinner than traditional thermocouples) and does not have a significant thickness footprint. As such, a larger number of film thermocouples can be used, as compared to other temperature sensors and wire or metal strip based thermocouples.

Each of the metallic inks or paints may be comprised of metal powder, a binder, and a solvent. The metal powder may be finely divided granules or may be thin flakes. The metal powder and the binder make up the dry ingredients of the ink and the solvent makes up the wet ingredient. The dry ingredients may be 79 to 99 percent metal powder and 1 to 21 percent binder, respectively, by dry weight.

The binder may be any film forming polymer. Potential binders include polyvinylidene fluoride (PVDF), carboxymethyl cellulose (CMC), polyacrylonitrile (PAN), Polyvinyl acid (PVA), polyacrylic acid (PAA), and styrene butadiene rubber (SBR). The solvents may be volatile or nonvolatile. Potential solvents include n-methylpyrrolidone (NMP), water, alcohol, and acetone. The solvent may be a mixture of different solvents, such as a water-acetone mixture.

The ink or paint is manufactured by mixing together the dry ingredients and adding an effective amount of solvent to form a liquid phase that is capable of being printed or painted onto the pouch 52. The ink or paint is then dried to form a film. The ink or paint may be dried at room temperature or at an elevated temperature. The pouches are heat sealed; therefore any elevated-temperate drying must be performed at less than 200 degrees Celsius to prevent damaging the seams.

The first and second terminals 72, 74 may also be formed of a metallic film or may be a strip of metal. In one embodiment, illustrated in FIG. 3, each of the terminals are formed of a solid metal strip that is electrically connected to the metallic film of a corresponding leg. The first terminal 72 may be made from the same metal as the film of the first leg, and the second terminal 74 may be made from the same metal as the film of the second leg 68. For example, if the metal powder of the first leg 66 is copper, then the first terminal 72 is made from a copper. The terminals may be joined to the film via ultra-sonic welding, clamping, adhesive, crimping, or other known methods. In some embodiments, the terminals are attached to the pouch 52 first, and subsequently, the legs of the thermocouple 64 are printed onto the pouch such that a portion of each leg is printed onto a corresponding terminal. Alternatively, the thermocouple is applied to the pouch first, and then the terminals are attached such that each terminal is overlaid onto a portion of a corresponding leg. Each of the terminals 72, 74 may include a portion 76 that extends beyond the edge 78 of the pouch 52.

In another embodiment, illustrated in FIG. 4, the first terminal 72′ is formed of the same metallic film as the first leg 66′, and the second terminal 74′ is formed of the same metallic film as the second leg 68′. The pouch 52′ includes a protruding tab 80 that extends beyond the main peripheral edge 82 of the terminal side 62′. The first and second terminals 72′, 74′ are disposed on the protruding tab 80. The first and second legs 66′, 68′ extend from an outer edge of the tab 80 towards an interior (or central) portion of the outer skin 54 of the pouch 52. In an alternative embodiment, the protruding tab 80 is a pair of protruding tabs that each includes one of the terminals. The first and second terminals 72′, 74′ may include a thicker layer of film to ensure robustness and reliability in connecting the terminals to connectors.

In one embodiment, the tab is a sacrificial substrate used to support the ink until it dries. Once the ink dries, the sacrificial tab is removed leaving a terminal formed of the film (i.e. dried ink). Additional coatings of ink maybe applied in the terminal portion of the legs to incrcase the strength of the film terminal. The sacrificial tab may be made of wax, Teflon®, or any other structure that is removable without damaging the film terminal.

The thermocouple 64 is disposed on the outer skin 54 in an area where a temperature reading is desirable. The cells 50 typically produce the maximum amount of heat near the terminal side 62. Therefore, it may be desirable to place the thermocouple junction there as shown in FIG. 2. But, it may also be desirable to determine the temperature of the cooler areas of the cell to ensure that all portions of the cell are above a minimal operating temperature threshold. Because thermocouples are cheap and relatively small, an individual cell 51 may include multiple thermocouples as shown in FIG. 5. By having multiple thermocouples, the temperature differential of the individual cells may be determined. A first thermocouple 90 is disposed near the terminal side of the cell and measures a temperature of the hotspot. The second thermocouple 92 disposed in the central region of the terminal and measures a temperature of an intermediate spot. A third thermocouple 94 is disposed near bottom edge of the cell and measures a temperature of the colder spot. By comparing these three temperature measurements the controller can determine a temperature differential across the cell 50.

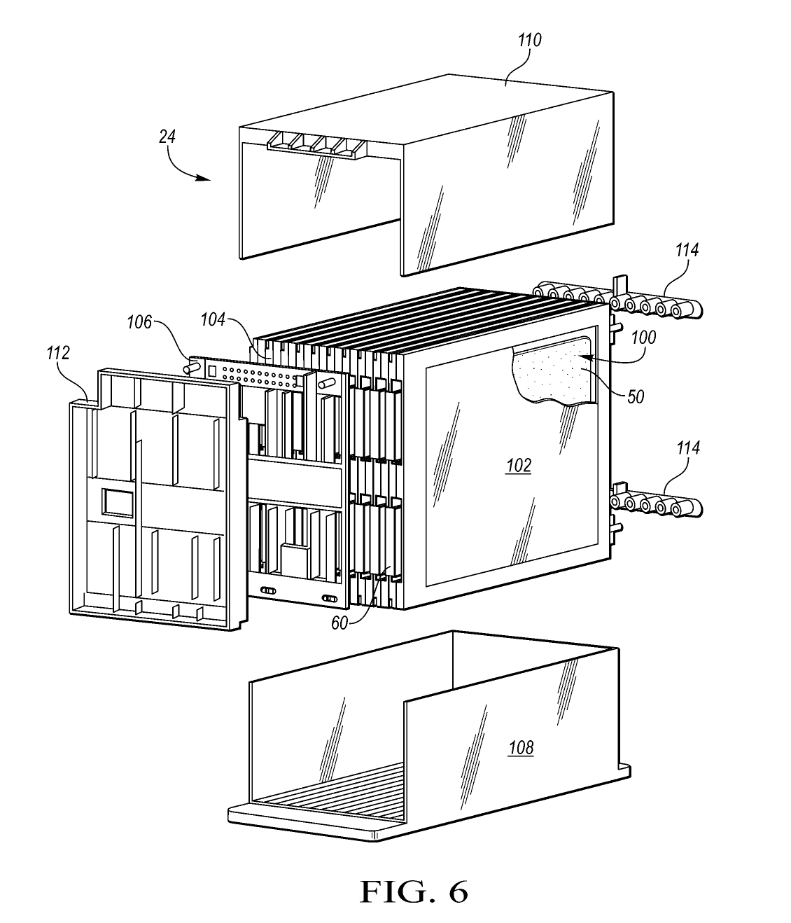

FIG. 6 illustrates a perspective view of the traction-battery assembly 24. The assembly 24 includes a cell array 100 having a plurality of cells 50 and a plurality of thermal plates 102 interleaved with the cells 50. Each of the cells 50 includes a retainer 104 that surrounds the mirror sides of the cell and helps secure the cell in the array 100. Each of the thermal plates 102 include inlet and outlet ports that connect with one of the manifolds 114. During operation, coolant is circulated through the manifolds and thermal plates to regulate a temperature of the array 100. A control board 106 is disposed on one side of the array 100. For example, the control board 106 is disposed on the terminal side of the array 100. The control board may include slots for receiving the terminals 60 of each of the cells. The terminals are electrically connected with the high-voltage bussing of control board 106 via weld, braising, or other means. The control board 106 is electrically connected with one or more of the vehicle controllers. The assembly 24 also includes a housing that surrounds the internal components of the traction battery 24. The housing may include a bottom 108, a top 110, and a front cover 112.

One or more of the cells 50 includes a thermocouple, such as thermocouple 64. The traction-battery assembly 24 may include one or more lead wires (not shown) that connects with the terminals of the thermocouple to electrically connect the thermocouples to one or more of the vehicle controllers. In order to provide more efficient packaging, the lead wires may be replaced with a printed circuit board that electrically connect with each of the thermocouples and one or more of the vehicle controllers.

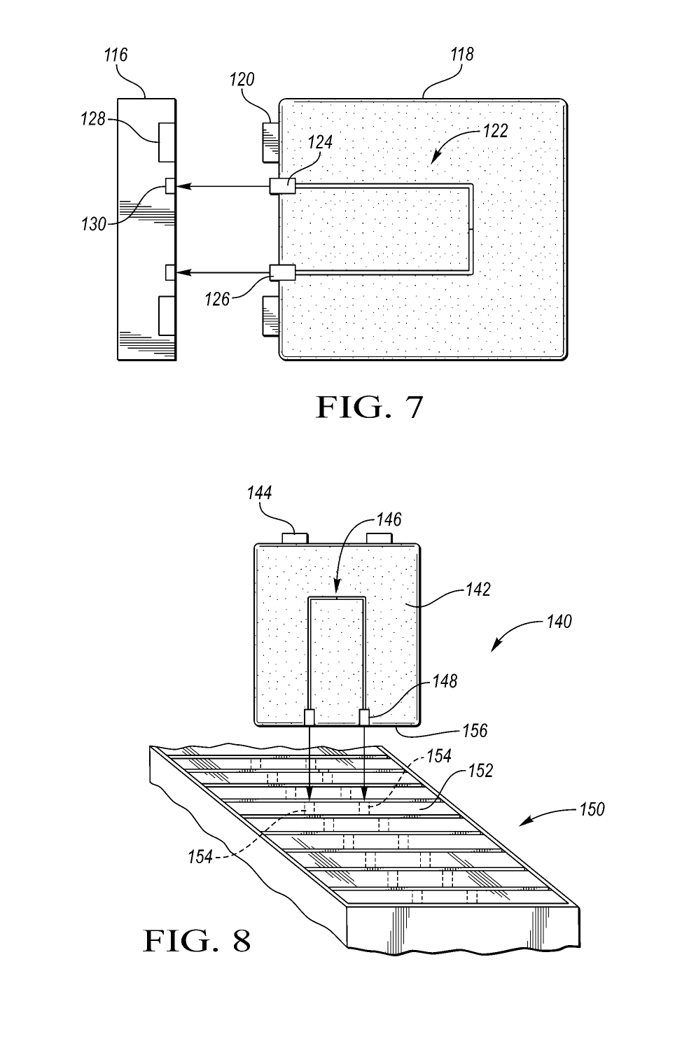

The printed circuit board may be a separate component or may be integrated with the control board 106. FIG. 7 illustrates a control board 116 that includes both high-voltage bussing for the cell terminals and bussing for the thermocouple terminals. A cell 118 includes a pair of cell terminals 120 extending from a terminal side of the cell. A thermocouple 122 is disposed on an outer skin of the cell 118. The thermocouple 122 may be similar to any of the thermocouples described above. The thermocouple 122 includes a first terminal 124 and a second terminal 126.

The control board 116 includes cell-terminal receptacles 128 that are each configured to receive one of the cell terminals 120. The control board 116 also includes thermocouple receptacles 130 that are each configured to receive one of the first or second terminals 124, 126 of thermocouple 122. The receptacles 130 include one or more electrical contacts for electrically connecting with the terminals 124, 126.

FIG. 8 illustrates another traction battery assembly 140. The assembly 140 includes a plurality of cells 142 each having cell terminals 144 extending from an upper edge of the cell. One or more of the cells 142 includes a thermocouple 146 having terminals 148 disposed near the lower edge 156 of the cell. The terminals 148 of thermocouple 146 may, or may not extend past an edge 156 of the cell 142. The traction-battery assembly 140 also includes a receiving board 150 having a plurality of slots 152. Each of the slots 152 receives the edge 156 of one of the cells 142 therein. The slots 152 are arranged to properly space each of the cells 142 within the traction battery 140. Each of the slots includes electrical contacts 154 arranged to connect with one of the terminals 148 of the thermocouple 146. The receiving board 150 may include a circuitry electrically connected with each of the electrical contacts 154 and with one or more of the vehicle controllers.

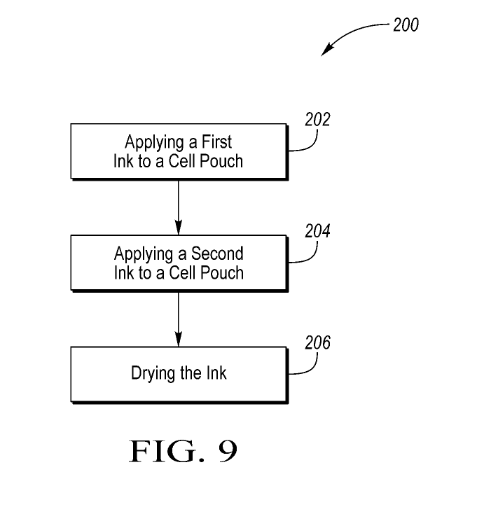

FIG. 9 illustrates a method 200 of forming a thermocouple on a cell. The thermocouple may be installed on the pouch either before, or after, the cell is manufactured. In one example, the thermocouple is applied to the pouch prior to the electrochemical components being installed. The pouch material may be prepared—by degreasing the pouch or roughening the outer surface of the pouch where the thermocouple is being installed—prior to applying the thermocouple. At step 202 a first ink (including a first metal powder) is applied to the skin of the pouch. The ink may be applied by printing or painting as described above. The ink may be applied in a first strip forming a first leg of the thermocouple. The ink strip may extend from an edge of the cell towards an interior portion, where it is desired to have a temperature reading. At step 204 second ink (including a second metal powder) is applied to the outer surface of the pouch such that the first and second inks connect at a junction. The first and second metal powders are dissimilar metals suitable to produce thermoelectric effect. The second ink may also be applied in a second strip forming a second leg of the thermocouple. The second ink strip may extend from an edge of the cell towards the interior portion and terminate at a junction. At step 206 the inks are allowed to dry either at room temperature or at an elevated temperature below 200° C. After the ink dries, the pouch may be fed through a pair of calendaring rollers to compress the first and second inks. This calendering may incrcase the electrical conductivity of the inks. In one embodiment, an electrical terminal is installed at the outer end of the ink strip. The electrical terminal may be strip of metal. If the pouch includes a protruding tab (as shown in FIG. 4) the first and second inks may be applied to the pouch such that the ink strips begin at an edge of the tab and extend towards a middle portion of the cell where the inks connect at a junction. After the thermocouple is installed on the pouch, the electrochemical components and other components are installed to form a finished cell.

In another example, the thermocouple is applied to the pouch after the electrochemical components of the cell are completely manufactured. Here, the pouch may be roughened at a location where the thermocouple is being installed. Next, the first and second inks are applied as described above.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. A traction battery comprising:
a plurality of cells arranged in an array and each including a pouch having an outer surface;
a circuit board including terminal receptacles; and
a thermal couple disposed on the outer surface of one of the cells, and including first and second legs each formed of a metal film and having a terminal extending away from the pouch and being inserted into one of the terminal receptacles.

2. The traction battery of claim 1 wherein each of the cells further includes a terminal and wherein the circuit board further includes additional receptacles each arranged to receive one of the terminals of the cells.

3. The traction battery of claim 2 wherein, for each of the cells, the terminals of the legs and the terminal of the cell extend from a same side of the cell.

4. The traction battery of claim 1 wherein the pouch further includes at least one tab extending outwardly from an edge of the cell and at least one of the terminals is disposed on the tab.

5. The traction battery of claim 4 wherein the tab is received within one of the receptacles of the circuit board.

6. The traction battery of claim 1 wherein the first metal film includes a first metal powder and binder, and the second metal film includes a second metal powder and binder.

7. A traction battery comprising:
a cell array including a cell having a pouch defining a tab extending therefrom; and
a thermal couple disposed on the pouch, and including first and second legs formed of a metal film, wherein a terminal portion of the first leg is disposed on the tab.

8. The traction battery of claim 7 wherein a terminal portion of the second leg is disposed on the tab.

9. The traction battery of claim 7 wherein the pouch further defines another tab extending therefrom and disposed on a same side of the cell as the tab, and wherein a terminal portion of the second leg is disposed on the another tab.

10. The traction battery of claim 7 further comprising a circuit board disposed against the array and including a receptacle arranged to receive the tab to electrically connect the terminal portion of the first leg with a controller.

11. The traction battery of claim 10 wherein each of the cells includes a cell terminal and wherein the circuit board further includes additional receptacles arranged to receive the cell terminals.

12. The traction battery of claim 11 wherein the tab is on a same side of the cell as the cell terminal.

13. The traction battery of claim 7 further comprising a receiving board including a slot having an electrical contact and arranged to receive a mirror side of the cell therein, wherein the tab is received within the slot such that the electrical contact is engaged with the terminal portion of the first leg.

14. The traction battery of claim 7 wherein the first metal film includes a first metal powder and binder, and the second metal film includes a second metal powder and binder.

15. A method of applying a thermal couple to a cell having a pouch, the method comprising:
applying a first ink, including a first metal powder, to an outer surface of the pouch; and
applying a second ink, including a second metal powder, to the outer surface such that the first and second inks connect at a junction, wherein the first and second metal powders are dissimilar metals configured to produce a thermoelectric effect.

16. The method of claim 15 further comprising
applying the first ink such that the ink extends from an outer edge of a tab protruding from the pouch towards an interior portion of the outer surface of the cell; and
applying the second ink such that the ink extends from an outer edge of the tab towards the interior portion.

17. The method of claim 16 wherein the cell further includes a terminal and the tab is located on a same side of the cell as the terminal.

18. The method of claim 15 wherein the pouch is formed of an aluminum-polymer laminate.

19. The method of claim 15 further comprising calendering the pouch to compress the first and second inks.
